(19) United States
(12) Patent Application Publication
(10) Pub. No.: US 2026/0167454 A1
(43) Pub. Date: Jun. 18, 2026

(54) CONTROLLING AN ELEVATOR USING A MOBILE DEVICE

(71) Applicant: Inventio AG, Hergiswil (CH)

(72) Inventors: Jacqueline Walther, Ebikon (CH); Donato Carparelli, Lugano (CH)

(21) Appl. No.: 18/715,161

(22) PCT Filed: Dec. 1, 2022
(86) PCT No.: PCT/EP2022/084085

§ 371 Date: May 31, 2024

(30) Foreign Application Priority Data
Dec. 6, 2021 (EP) 21212422.6

(51) Int. Cl. B66B 1/28; B66B 1/24; B66B 1/34; B66B 1/46

(52) U.S. Cl. CPC B66B 1/28; B66B 1/2408; B66B 1/2458; B66B 1/3461; B66B 1/468; B66B 2201/103; B66B 2201/4615

(57) ABSTRACT

A method for controlling an elevator includes: generating a user request using a mobile device of a user of the elevator, wherein the user request defines at least one operating parameter for adapting an operating behavior of the elevator; transmitting the user request from the mobile device to a control system to control the elevator; and generating control commands from the user request, by the control system, such that the operating behavior of the elevator is adapted according to the at least one operating parameter, and the elevator moves to a destination floor defined by the user in accordance with the adapted operating behavior.

### FIELD

The present invention relates to a method for controlling an elevator. Furthermore, the invention relates to an elevator system and to a computer program for carrying out the method, and to a computer-readable medium on which such a computer program is stored.

### BACKGROUND

An elevator that can be used, for example, for conveying people in buildings, is generally controlled via buttons in the door area or in the elevator car. In addition, the elevator can be controlled contactlessly by means of a mobile device, such as a smartphone or tablet. A corresponding application can be installed on the mobile device for this purpose. The application can be configured to select a destination floor and to transmit a corresponding user request via a wireless data communication connection to a control system, which can generate corresponding control commands for the elevator. The functionality of such a contactless elevator control is usually limited to the selection of a desired destination floor. In particular in residential buildings, it would be desirable for reasons of comfort if the user could influence the operating behavior of the elevator via their mobile device, in addition to specifying the destination floor.

### SUMMARY

There may therefore be a need for a method for controlling an elevator in which the user can specifically influence the operating behavior of the elevator.

This need can be met by the subject matter of the advantageous embodiments defined in the following description, as well as the accompanying drawings.

A first aspect of the invention relates to a computer-implemented method for controlling an elevator system. The method comprises at least the following steps: generating a user request using a mobile device of a user of the elevator, wherein the user request defines at least one operating parameter for adapting an operating behavior of the elevator; transmitting the user request from the mobile device to a control system to control the elevator; and generating control commands from the user request, by the control system, such that the operating behavior of the elevator is adapted in accordance with the at least one operating parameter, and the elevator moves to a destination floor defined by the user in accordance with the adapted operating behavior.

The method can be carried out automatically, for example by a processor of the mobile device and/or a processor of the control system.

A second aspect of the invention relates to an elevator system which comprises a control system for controlling an elevator and at least one mobile device of a user of the elevator. The elevator system is configured to carry out the method described above and below for controlling an elevator. For this purpose, the control system can be connected to the mobile device or to the mobile devices for data communication.

The control system and the mobile device can each comprise a processor which is configured to carry out the corresponding steps of the method described above and below. The control system and the mobile device can each comprise hardware and/or software modules. In addition to the processor, the control device may comprise a memory and data communication interfaces for data communication with peripheral devices.

In addition, the elevator system can comprise the elevator itself. The elevator can comprise an elevator shaft and at least one car movable between multiple floors along the elevator shaft. The phrase, “the elevator moves to the destination floor in accordance with the adapted operating behavior,” can be understood in such a way that the user is picked up by one of the cars of the elevator, and the car is moved along the elevator shaft in accordance with the adapted operating behavior to the destination floor, and holds there.

Features of the method described above and below can also be interpreted as features of the elevator system and vice versa.

Further aspects of the invention relate to a computer program and a computer-readable medium in which the computer program is stored.

The computer program comprises commands which cause the elevator system described above and below to carry out the method described above and below.

The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the method described above and below can also be interpreted as features of the computer program and/or of the computer-readable medium, and vice versa.

Without restricting the scope of the invention in any way, embodiments of the invention may be considered to be based, among other things, on the concepts and findings described below.

“Mobile device” can be understood to mean a portable device controlled by a processor, such as a smartphone, a tablet, a smartwatch, or a laptop. The processor is configured for data processing. A special application can run on the mobile device, which can be configured such that the user can set one or more operating parameters of the elevator, and, in addition, can select different destination floors. The destination floor can thus be defined by the user by means of the mobile device and/or by actuating a corresponding button of the elevator. The application can generate a corresponding user request therefrom and transmit via a suitable data communication connection, for example WLAN, Bluetooth and/or mobile radio, for further processing to the control system of the elevator.

The operating behavior of the elevator can be understood to mean a manner in which a car of the elevator is to be moved to the destination floor. The operating behavior can be selectively influenced by the operating parameter(s) transmitted by the mobile device. It is thus not only possible to specify where, i.e., up to which floor, the car is to be moved, but also how the car is to be moved toward the location. In particular, the operating behavior can be adapted to the user's wishes in order to improve the comfort and convenience for the user.

For example, the control system can comprise a central server that can receive and process user requests of different mobile devices. For example, the server can be configured to forward the user requests to a local control device of the elevator, which can also be a component of the control system and can be connected to the server for data communication. The control device can be configured to control an actuator system of the elevator. It is also conceivable that the server generates control commands for the elevator directly from the user requests and forwards them to the control device, which then converts the control commands accordingly.

The data communication between the server and the control device and/or between the server and the mobile devices can take place, for example, via the Internet.

It is possible that the server receives user requests of users of different elevators and processes them accordingly—for example, forwards them to the corresponding control systems and/or converts them into corresponding control commands for the corresponding elevator.

The operating parameter and/or the operating parameters can, for example, be set in the application by the user by activating or deactivating a switch and/or by selecting a value from a specified value range. The destination floor can be selected in a corresponding manner.

It is possible for multiple operating parameter configurations to be stored in the application, which in each case define a specific operating behavior or a specific operating mode of the elevator. By selecting one of these operating parameter configurations, the user can thus cause the operating behavior of the elevator to change in the manner specified by the user, or the elevator is put into one of multiple possible operating modes in accordance with the specifications of the user, in order to move the user to the destination floor.

Users can thus easily adapt the behavior of the elevator to their individual wishes and needs, which considerably improves comfort.

According to one embodiment, the user request can additionally define the destination floor. In other words, the user can select the destination floor using their mobile device. The operating comfort can thus be further improved.

According to one embodiment, the user request can define at least one of the following operating parameters: an elevator speed at which the elevator is to travel to the destination floor, an opening and/or closing speed at which the elevator is to be opened and/or closed, i.e., with which the one door or doors of the elevator is/are to be opened and/or closed, a number and/or user category of other users which should travel together with the user; floors at which the elevator should stop and/or not stop before reaching the destination floor; a preferred period of use in which the elevator is preferably used; an energy consumption of the elevator; a brightness and/or color of car lighting of the elevator. For example, the user can enter in the mobile device that the elevator should move without an intermediate stop up to the selected destination floor. It is also conceivable that the user selects individual floors at which the elevator should not stop. On the basis of the user category, the user can, for example, be categorized as “neighbor,” “user with unrestricted access authorization,” or “user with restricted access authorization.” For example, the “user with restricted access authorization”—in contrast to the “user with unlimited access authorization”—cannot select or set all possible destination floors, and/or not all possible operating parameters, with their mobile device. However, any other user categories are conceivable, depending on the elevator type or building type. This embodiment enables a differentiated adaptation of the operating behavior of the elevator to the wishes and needs of the respective user.

Each of the aforementioned operating parameters can be set by users themselves with the mobile device, i.e., in an application running on the mobile device, and transmitted from the mobile device to the control system in the form of a corresponding user request.

A change and/or expansion of the operating parameters definable by the user with their mobile device, for example in the event of a change and/or expansion of the configuration of the elevator, can be carried out, for example, via a corresponding update of the application.

In addition, the user request can comprise at least one of the following pieces of information, which can be taken into account during the generation of the control commands: a starting floor from which the elevator will travel to the destination floor, a current location of the user and/or of the elevator, for example in the form of geographical coordinates; a user ID which allows a unique identification of the user, an elevator ID which enables a unique identification of the elevator.

As mentioned further above, in order to generate the user request according to one embodiment, one of multiple prespecified operating parameter configurations can be selected, wherein each operating parameter configuration can define settings for multiple operating parameters. Different operating parameter configurations can differ from one another in at least one setting. Each operating parameter configuration can define a specific setting for each operating parameter. If, for example, five operating parameters can be set via the mobile device, each operating parameter configuration can define a specific setting for each of the five operating parameters. In other words, the user can set multiple operating parameters at once by selecting such an operating parameter configuration without having to set each operating parameter individually. This simplifies operation and avoids errors in the input. The operating parameter configurations can, for example, be created and modified by the user himself, and/or can be stored in the application as standard.

According to one embodiment, the user request can be linked to a user profile in which information about the user is stored. In this case, the control commands can additionally be generated, taking into account the user profile. A prior registration of the user may be required for the user to control the elevator with their mobile device. A user profile can be created which, on the one hand, can enable a unique identification of the user, i.e., a unique differentiation of the user from other users of the elevator, and on the other hand can describe certain properties of the user, for example relationships of the user to other users, a history of earlier user requests of the user, an access authorization of the user, or personal information such as contact data of the user. The security of the method can thus be increased. Furthermore, the information stored in the user profile can contribute to a more efficient processing of the user requests.

According to one embodiment, the user profile can display a user category of the user from among multiple specified user categories, and/or enable an assignment of the user to one of multiple specified user categories. Possible examples of user categories are “neighbors,” “users with unrestricted access authorization,” or “user with restricted access authorization” (see further above). The user category can be selected by the user himself and/or automatically assigned to their user profile on the basis of the information contained therein. An external assignment is also possible by another user, for example an administrator or a resident of a building in which the elevator is installed. This embodiment enables a limitation and/or expansion of the control options as a function of the user category of the corresponding user.

According to one embodiment, the user request can be transmitted from the mobile device to the control system via a wireless data communication connection and/or via the Internet. This enables a decentralized control of the elevator by the mobile device.

According to one embodiment, different user requests can be generated by different mobile devices of different users of the elevator, wherein each user request defines at least one operating parameter for adapting the operating behavior of the elevator. Each user request can be sent by the corresponding mobile device to the control system. The control commands can be generated in such a way that the operating behavior of the elevator is adapted for each user request and the elevator moves to the destination floor defined by the corresponding user in accordance with the corresponding adapted operating behavior. In other words, the control system can be configured to receive and process multiple user requests in parallel. For this purpose, the control system can assign a priority to each user request according to certain criteria, for example, and process the user requests according to their priority, i.e., convert them into corresponding control commands for the elevator. The priority can depend, for example, on the time of receipt of the user request, on the content of the user request and/or of the user profile and/or of the user category of the corresponding user. As mentioned above, each user can select their destination floor using their corresponding mobile device and/or by actuating the corresponding button in the elevator.

In addition, the method can comprise the following steps: generating a message with information regarding the user request, by the control system, and transmitting the message from the control system to the mobile device of the user. The message can indicate, for example, an estimated wait time and/or travel time. The message can, for example, be displayed on a display of the mobile device. Additionally or alternatively, the message can be displayed on a panel of the floor, and/or car panel. In this way, the user can be kept informed regarding the status of their user request. It is also conceivable that multiple users communicate with one another via the control system, i.e., messages are sent to one another via the control system.

Advantageous embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to an embodiment of the invention.

FIG. 2 shows a mobile device of the elevator system of FIG. 1 in detail.

The drawings are merely schematic, and not to scale. Like reference signs refer in different drawings to like or analogous features.

### DETAILED DESCRIPTION

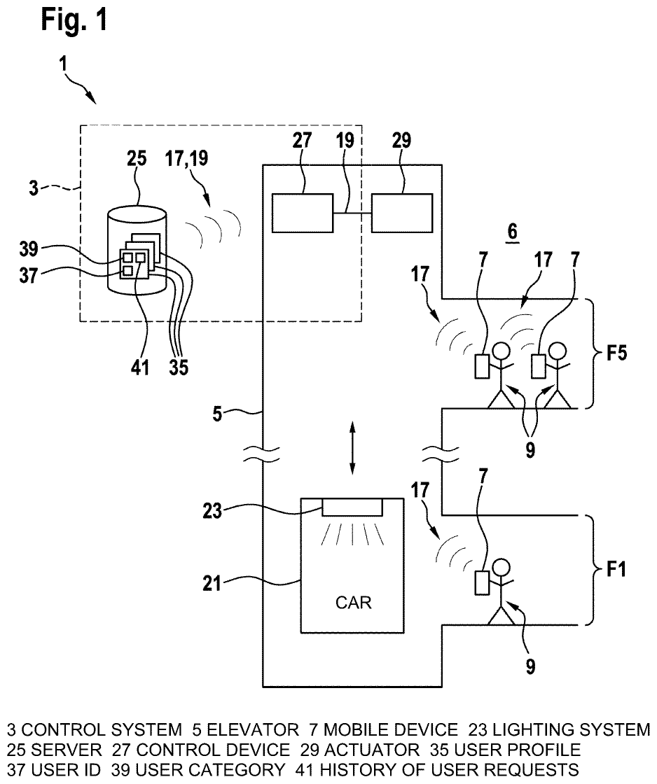

FIG. 1 shows an elevator system 1 which comprises a control system 3 for controlling an elevator 5, for example a passenger elevator for conveying persons between multiple floors F1 to F5 of a building 6, for example a residential building. Furthermore, the control system 3 can comprise multiple mobile devices 7 of users 9 of the elevator 5, wherein each mobile device 7 is connected to the control system 3 for data communication.

In this example, data communication takes place wirelessly, for example via WLAN, Bluetooth, and/or mobile radio.

The elevator system 1 is configured to control the elevator 5 in the method described in more detail below.

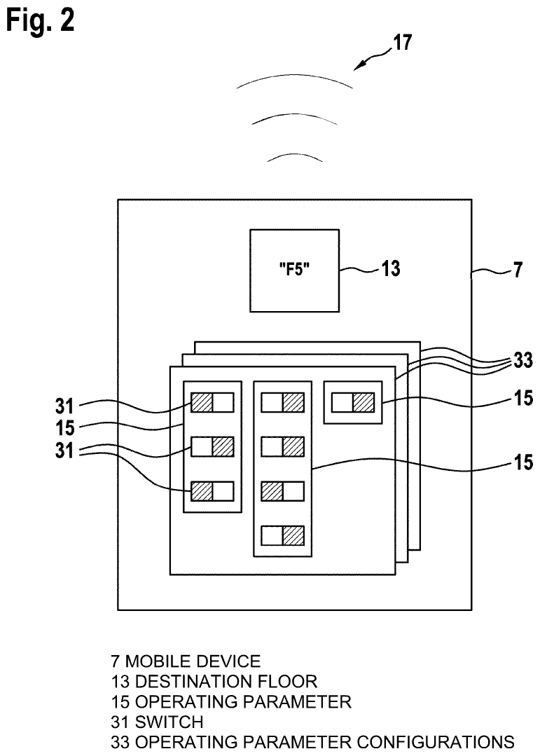

For this purpose, each user 9 outputs a destination floor 13 in an application running on their corresponding mobile device 7, for example “F1” for the first floor of the building 6 or “F5” for the fifth floor of the building 6, and in this case selects a specific setting for at least one operating parameter 15 with which the operating behavior of the elevator 5 can be influenced in a targeted manner (see FIG. 2). Corresponding to the inputs of the user 9, the mobile device 7 generates a user request 17 and sends it to the control system 3.

The mobile device 7 can be, for example, a smartphone, a smartwatch, a tablet, a laptop, or another portable computer.

In this example, the control system 3 thus receives multiple user requests 17 which have been provided by different mobile devices 7, i.e., from different users 9.

The control system 3 then generates control commands 19 for the elevator 5 from these user requests 17. These can be generated in such a way that the operating behavior of the elevator 5 is individually adapted for each user 9 and/or each user request 17 according to the corresponding setting for the operating parameter(s) 15, and each user 9 is moved by the elevator 5 to their respective destination floor 13, i.e., to one of the floors F1 to F5, in accordance with the corresponding adapted operating behavior.

Examples of suitable operating parameters 15 are: an elevator speed at which a car 21 of the elevator 5 is to be moved to the desired floor F1 to F5; an opening and/or closing speed at which the elevator 5, i.e., its door(s), should be opened and/or closed; a number and/or user category of other users which should travel together with the user 9 in the same car 21; floors F1 to F5 at which the car 21 should stop and/or should not stop before the destination floor 13 is reached, a preferred period of use in which the elevator 5 is preferably used; an energy consumption of the elevator 5; a brightness and/or color of a car lighting system 23 in the car 21.

For example, choices for the elevator speed can be between the settings “slow” and “default,” for the opening and/or closing speed between the settings “slow,” “medium” and “fast,” for the energy consumption between the settings “efficient” and “standard,” for the preferred period of use between the settings “1 p.m. to 3 p.m.” and “10 p.m. to 6 a.m. ,” for the user category between the settings “every,” “only neighbors” and “only confirmed users,” and for the brightness and/or color of the car lighting system 23, between the settings “hot,” “cold,” and “dark.”

Depending on the selected setting for the energy consumption, the operating behavior of the elevator 5 can be adapted such that either the efficiency of the passenger transport or the energy efficiency is prioritized.

An operating parameter 15, “operating mode,” for which, for example, a choice can be made between at least two of the following settings, is also possible: “exclusive,” “restricted exclusive,” “standard,” “guest or safety mode,” “priority” (see below).

For example, the control system 3 can comprise a server 25 in which the user requests 17 of different users 9 of the same elevator 5 and/or of different elevators 5 can be received and processed centrally.

The server 25 can be configured to forward the user requests 17 to a local control device 27 for controlling an actuator 29 of the elevator 5. In this case, the control commands 19 can be generated from the user requests 17 by the control device 27.

Alternatively, the control commands 19 can be generated from the user requests 17 by the server 25 itself and sent to the control device 27.

The server 25 can be connected to the mobile devices 7 and/or to the control device 27, for example via the Internet, for data communication.

The data communication between the server 25 and the control device 27 can take place via a wireless and/or wired data communication connection.

The server 25 can, for example, be a component of a cloud.

As indicated schematically in FIG. 2, the user 9 can select on their mobile device 7 between different settings for each operating parameter 15, for example by activating or deactivating one or more switches 31.

In order to simplify the selection of the operating parameters 15, different operating parameter configurations 33 can be stored on the mobile device 7 and/or retrieved from the mobile device 7 if required, for example via the server 25. The operating parameter configurations 33 can be created by the corresponding user 9 himself, and/or predefined as standard. Different operating parameter configurations 33 can differ from one another in at least one setting.

It is possible for each user request 17 to be linked to a user profile 35 of the corresponding user 9, in which information regarding the user 9, such as a unique user ID 37, a user category 39, or a history 41 of previous user requests 17 of the user 9 can be stored. For example, the user profile 35 can be created during an initial registration of the user 9 and/or stored on the server 25.

The information 37, 39, 41 contained in the user profile 35 can be taken into account in a corresponding manner when generating the control commands 19.

By a corresponding setting of the operating parameters 15 and/or by selecting a corresponding operating parameter configuration 33, the following operating modes of the elevator 5 can be realized, for example.

Exclusive: The user 9 enters an empty car 21 and is moved alone to the destination floor 13, i.e., without other users embarking.

Restricted exclusive: In addition to the destination floor 13, the user 9 defines floors F1 to F5 in which the car 21 may stop, and/or how many other users at most may embark.

Standard: This can be a pre-configured operating mode of the elevator 5 defined by an administrator, for example a building manager.

Guest or safety mode: The user 9 can select only one of the possible floors F1 to F5 as a destination floor 13, due to their user category 39. In this mode, the function for setting the operating parameters 15 and/or for selecting the operating parameter configurations 33 can be deactivated or severely restricted for the user 9.

Priority: The registered user 9 is moved without further interaction to their usual destination floor 13. For this purpose, the user 9 can be identified as a preferred user using their user ID 37 and/or user category 39, for example, and a corresponding user request 17 can automatically be generated by the mobile device 7 and sent to the control system 3. The user request 17 can be generated automatically, for example, on the basis of the history 41 of the earlier user requests 17 of the user 9.

Finally, it should be noted that terms such as “having,” “comprising,” etc. do not exclude other elements or steps, and indefinite articles such as “a” or “an” do not exclude a plurality. Furthermore, it is noted that features or steps described with reference to one of the preceding embodiments can also be used in combination with features or steps described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A method for controlling an elevator, the method comprising the steps of:
enabling a mobile device of a user of the elevator to generate and transmit a user request, wherein the user request defines at least one operating parameter for adapting an operating behavior of the elevator, the user request being generated by selecting with the mobile device one of multiple prespecified operating parameter configurations, each of the operating parameter configurations defining settings for multiple operating parameters;
receiving the user request, transmitted from the mobile device, by a control system controlling the elevator; and
generating control commands by the control system based on the user request, wherein the control commands adapt the operating behavior of the elevator according to the at least one operating parameter, and the elevator travels to a destination floor defined by the user in accordance with the adapted operating behavior.

13. The method according to claim 12 wherein the user request defines the destination floor.

14. The method according to claim 12 wherein the at least one operating parameter is:
an elevator speed at which the elevator is to travel to the destination floor;
an opening and/or closing speed at which the elevator is to be opened and/or closed;
a number and/or user category of other users who are to ride together with the user and/or should not ride together with the user;
floors at which the elevator should stop, and/or should not stop, before the destination floor is reached;
a preferred period of use in which the elevator is preferably used;
an energy consumption of the elevator; or
a brightness and/or color of a car lighting system of the elevator.

15. The method according to claim 12 wherein the user request is linked to a user profile storing information regarding the user, and wherein the control commands are generated taking into account the information stored in the user profile.

16. The method according to claim 15 wherein the user profile information includes a user category of the user and/or an assignment of the user to one of multiple specified user categories, and wherein the control commands are generated taking into account the user category included in the user profile information.

17. The method according to claim 12 wherein the user request is transmitted from the mobile device to the control system via a wireless data communication connection and/or via the Internet.

18. The method according to claim 12 including:
enabling different user requests to be generated by different mobile devices of different users of the elevator, each of the different user requests defining at least one operating parameter for adapting the operating behavior of the elevator;
wherein each of the different user requests is transmitted from a corresponding one of the different mobile devices to the control system; and
wherein the control system generates the control commands such that the operating behavior of the elevator is adapted for each of the different user requests and the elevator travels in accordance with the corresponding adapted operating behavior to a destination floor defined by a corresponding one of the different users.

19. An elevator system comprising:
an elevator having a car movable to multiple floors;
a control system controlling the elevator using the method according to claim 12; and
wherein the control system is adapted to receive the user request from the mobile device enabled to generate and transmit the user request.

20. The elevator system according to claim 19 wherein the control system communicates with the mobile device via a wireless data communication connection and/or via the Internet.

21. A computer program product comprising computer program instructions that, when stored on a non-transitory computer-readable medium and executed by a processor of a control system for an elevator, cause the control system to perform the method according to claim 12.

22. A non-transitory computer-readable medium on which the computer program instructions according to claim 21 are stored.
